(19) United States
(12) Patent Application Publication
(10) Pub. No.: US 2006/0239303 A1
(43) Pub. Date: Oct. 26, 2006

(54) Method of performing periodical synchronization for ensuring start of super frame in residential Ethernet system

(75) Inventors: Jae-Hun Cho, Seoul (KR); Jong-Ho Yoon, Goyang-si (KR); Kwan-Soo Lee, Seoul (KR); Yun-Je Oh, Yongin-si (KR); Jun-Ho Koh, Suwon-si (KR); Si-Hai Wang, Suwon-si (KR); Sang-Ho Kim, Hwaseong-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/410,422

(22) Filed: Apr. 25, 2006

(30) Foreign Application Priority Data
Apr. 26, 2005 (KR) 34768/2005

(51) Int. Cl. H04J 3/06; H04J 3/12; H04J 3/02

(52) U.S. Cl. 370/537; 370/503; 370/528

(57) ABSTRACT

Disclosed is a method of performing a periodical synchronization at a predetermined transmission link for ensuring a start of a super frame in a residential Ethernet system. The method includes the steps of ensuring a start of a first predetermined super frame at the predetermined transmission link, transmitting Sync frames and Async frames through a predetermined number (N-1) of super frames, in which N is a total number of the super frames, and controlling an Async frame to be transmitted at an end point of the (N-1) super frames in such a manner that a start of a next super frame (N^{th} super frame) is strictly ensured, thereby maintaining a synchronization for the start of the super frame.

### CLAIM OF PRIORITY

This application claims the benefit under 35 U.S.C. 119(a) of an application entitled “Method Of Performing Periodical Synchronization For Ensuring Start of Super Frame In Residential Ethernet System,” filed with the Korean Intellectual Property Office on Apr. 26, 2005 and assigned Serial No. 2005-34768, the contents of which are incorporated herein by reference.

### BACKGROUND OF THE INVENTION

1. Field of the Invention

The present invention relates to a residential Ethernet system capable of simultaneously providing real-time and non real-time services using the Ethernet. More particularly, the present invention relates to a method of strictly ensuring the start of a super frame in a residential Ethernet system.

2. Description of the Related Art

Ethernet is the most widely used local area network technology which is defined as a standard in an Institute of Electrical and Electronics Engineers (IEEE) 802.3. The Ethernet is a technology generally used when data are transmitted among a plurality of terminals or users. According to the IEEE 802.3 standard, a competitive access is accomplished by means of a carrier sense multiple access/collision detect (CSMA/CD) protocol, and a service frame of an upper layer is converted to an Ethernet frame while maintaining an inter frame gap (IFG) during transmission of the Ethernet frame. In this case, upper service frames are transmitted according to the generation sequence regardless of the type thereof. Such Ethernet has drawbacks in transmitting moving pictures or voice data sensitive to the transmission delay. To address this, various technologies have been suggested so as to transmit synchronous data, such as video/voice data, using the Ethernet. Such an Ethernet used for transmitting the synchronous data is called “residential Ethernet”.

Frames are transmitted in a cycle unit in the residential Ethernet. In general, one cycle is composed of 125 μsec, and includes a Sync field for transmitting synchronous frames and an Async field for transmitting asynchronous frames. A frame including the synchronous and asynchronous frames transmitted within the one cycle is called a “super frame”.

However, if the start of the super frame is strictly applied when transmitting frames in the residential Ethernet system (that is, if the synchronous frame must be transmitted at a start point of the super frame), it is necessary to compulsively hold or fragment the asynchronous frames. In this case, the band efficiency for the asynchronous frames is significantly degraded.

FIG. 1 illustrates the transmission cycle of a conventional residential Ethernet for ensuring the start of a super frame.

Referring to FIG. 1, the conventional residential Ethernet forms a data transmission cycle using a super frame of 125 μsec, and the super frame includes a Sync field 11-1 or 11-2 and an Async field 12-1 or 12-2. In particular, the conventional residential Ethernet transmits Sync frames 111-1 to 111-11 at start points 101, 102 and 103 of the super frames, thereby ensuring the start of the super frame.

To this end, final Async frames 112-2 and 112-4 of the super frames must be coincidently processed with end points of the super frames. Processing schemes for the final Async frames 112-2 and 112-4 of the super frames include a hold scheme, a fragmentation scheme, and a hold-fragmentation scheme.

According to the hold scheme, when the size of the Async frame exceeds the size of an empty field of the present super frame, the Async frame is held such that the Async frame can be transmitted during the next super frame, thereby strictly ensuring the start of the next super frame. At this time, the present super frame is transmitted while maintaining the empty field as it is.

According to the fragmentation scheme, when the size of the Async frame to be currently transmitted exceeds the size of an empty field of the present super frame, the Async frame is fragmented into a first fragmented Async frame matching with the empty field of the present super frame and a second fragmented Async frame. Thereafter, the first fragmented Async frame is transmitted with the present super frame, and the second Async frame is transmitted with the next super frame, thereby strictly ensuring the start of the next super frame.

In addition, according to the hold-fragmentation scheme, a predetermined threshold value corresponding to the empty field of the present super frame is established. In this state, if the size of the empty field exceeds the predetermined threshold value, the fragmentation scheme is employed, and otherwise, the hold scheme is employed.

However, if the start of the super frame is strictly ensured through the above schemes, a field for transmitting the Async frame must be emptied or fragmented to include an additional header, and as a result, the band efficiency for the Async frame may be degraded. In addition, since the above procedure must be performed for every super frame, not only is processing time loss incurred, but also it is difficult to compensate for the time delay.

To solve the above problem, as shown in FIG. 2, another conventional scheme similar to a conventional technology suggested by IEEE 1394 has been proposed. According to this conventional scheme, a transmission of the Sync frame is ensured within a transmission field of two super frames per a transmission node, thereby ensuring a superior QoS when the real-time service of the Sync frame is provided while preventing the band efficiency of the Async frame from being degrade.

FIG. 2 shows a transmission cycle in the conventional residential Ethernet, in which transmission of the Sync frame is ensured within two super frames per a node.

Referring to FIG. 2, the conventional residential Ethernet includes four transmission links 21, 22, 23 and 24, which are synchronized with the same master clock. That is, the transmission links 21, 22, 23 and 24 are operated according to the same cycle timer.

In addition, when each Sync frame passes through each transmission link, the Sync frame is simply needed to be transmitted to the next transmission link within two cycle timers, and it is not necessary to ensure the start of the super frame, so the band efficiency of the Async frame may not be degraded.

Regarding the operation of the Sync frame 201, the Sync frame 201 is transmitted to the first cycle at the first link 21 and transmitted to the third cycle at the second link 22, so that the Sync frame 201 can be transmitted to the next transmission link within two cycles. The Sync frame 201 is transmitted to the fifth cycle at the third link 23 and transmitted to the seventh link at the fourth link 24. Transmission of Sync frames 205, 208 and 211 is identical to the transmission of the Sync frame 201.

However, according to the conventional residential Ethernet as shown in FIG. 2, in which a transmission of the Sync frame is ensured within two super frames per a node, the transmission links 21, 22, 23 and 24 must be synchronized with one master clock, that is, “time of day” is necessarily needed. For this reason, algorithm and protocol for “time of day” are necessary.

### SUMMARY OF THE INVENTION

Accordingly, the present invention has been made to solve the above-mentioned problems occurring in the prior art and provides additional advantages, by providing a method for performing a periodical synchronization for ensuring the start of a super frame in a residential Ethernet system in order to obtain a superior QoS of Sync frames while improving the band efficiency of Async frames by using a residential Ethernet.

According to the present invention, there is provided a method of performing a periodical synchronization at a predetermined transmission link for ensuring a start of a super frame in a residential Ethernet system, the method comprising the steps of: i) ensuring a start of a first predetermined super frame at the predetermined transmission link; ii) transmitting Sync frames and Async frames through a predetermined number (N-1) of super frames, in which N is a total number of the super frames; and iii) controlling an Async frame to be transmitted at an end point of the (N-1) super frames in such a manner that a start of a next super frame (N^{th} super frame) is strictly ensured, thereby maintaining the synchronization for the start of the super frame.

### BRIEF DESCRIPTION OF THE DRAWINGS

The above features and advantages of the present invention will be more apparent from the following detailed description taken in conjunction with the accompanying drawings, in which:

FIG. 1 illustrates a transmission cycle of a conventional residential Ethernet system for ensuring the start of a super frame;

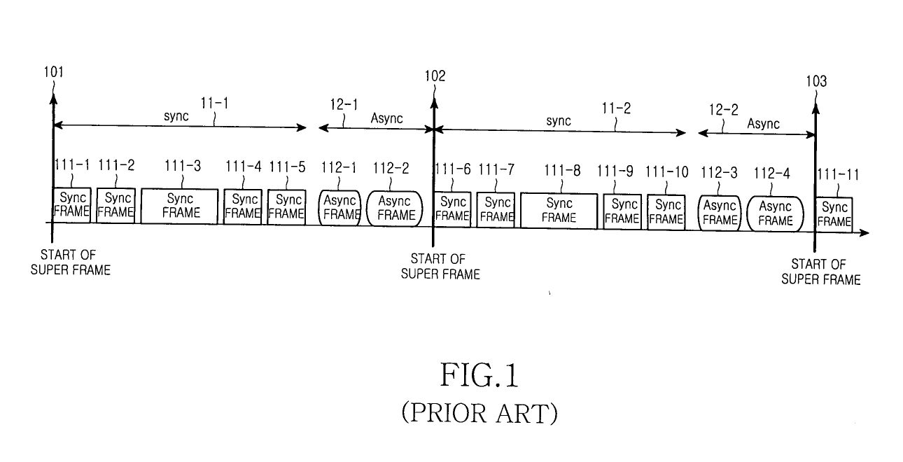

FIG. 2 illustrates a transmission cycle of another conventional residential Ethernet system for ensuring a transmission of Sync frames within two super frames per a node;

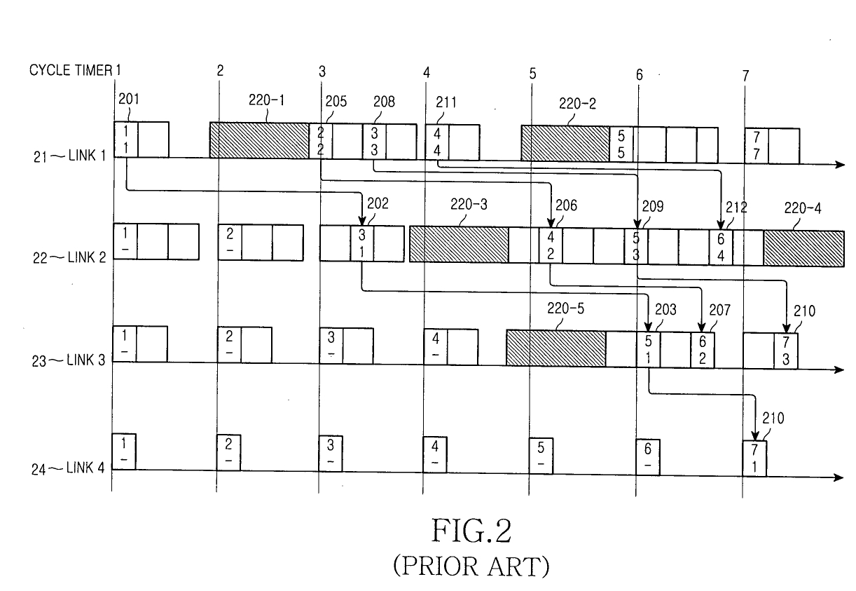

FIG. 3 illustrates a transmission cycle of a residential Ethernet system according to the present invention, in which a periodical synchronization scheme is applied for selectively ensuring the start of super frames;

FIG. 4 illustrates a first scheme for processing Async frames to achieve a strict periodical synchronization for the start of super frames in a residential Ethernet system according to the present invention;

FIG. 5 illustrates a second scheme for processing Async frames to achieve strict periodical synchronization for the start of super frames in a residential Ethernet system according to the present invention;

FIG. 6 is a flowchart illustrating a third scheme for processing Async frames to achieve a strict periodical synchronization for the start of super frames in a residential Ethernet system according to the present invention; and

FIG. 7 illustrates a fourth scheme for processing Async frames to achieve strict periodical synchronization for the start of super frames in a residential Ethernet system according to the present invention.

### DETAILED DESCRIPTION

Hereinafter, embodiments of the present invention will be described with reference to the accompanying drawings. For the purposes of clarity and simplicity, a detailed description of known functions and configurations incorporated herein will be omitted as it may make the subject matter of the present invention unclear.

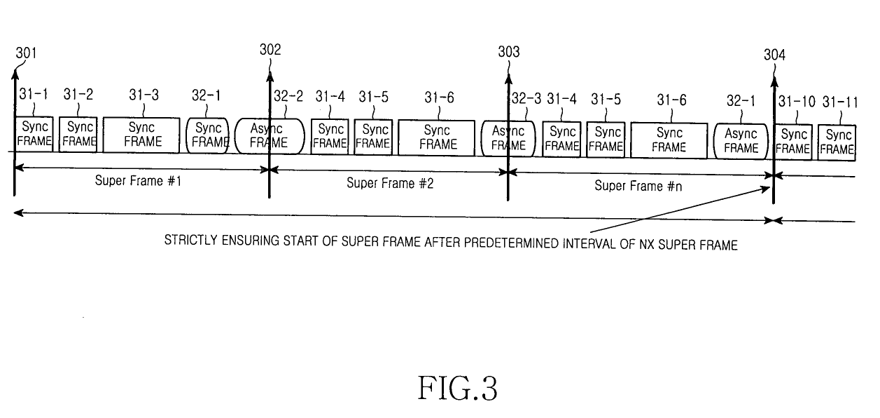

FIG. 3 is a view illustrating a transmission cycle of a residential Ethernet system according to the present invention, in which a periodical synchronization scheme is applied for selectively ensuring the start of super frames.

Referring to FIG. 3, unlike the conventional residential Ethernet system, which strictly ensures the start of all super frames, the residential Ethernet system according to the present invention selectively ensures the start of specific super frames spaced from each other at a predetermined interval (n).

That is, as shown in FIG. 3, according to the periodical synchronization scheme for ensuring the start of the super frame of the present invention, a start 301 of a super frame is strictly ensured, and Sync frames 31-1 to 31-6 and Async frames 32-1 to 32-4 can be freely transmitted during other super frames. In addition, after a predetermined interval has elapsed from the start 301 of the super frame, a start 304 of a super frame is strictly ensured.

In this manner, if the start of the super frames is periodically ensured, the band efficiency for the Async frames can be improved when compared with that of the conventional technology. In addition, the processing time can be reduced and the structure of the residential Ethernet system can be simplified as compared with those of the conventional Ethernet systems, which repeats various algorithms for every super frame to ensure the start of the super frames.

Moreover, unlike the conventional scheme, in which transmission of the Sync frame is ensured within two super frames per a node, if the start of the super frames is selectively ensured on the basis of a predetermined interval, it is not necessary to provide the same master clock for all transmission links. That is, it is sufficient if the transmission links are individually synchronized. In other words, after ensuring the start of the specific super frame at each transmission link, if the start of another specific super frame is ensured after a predetermined interval has elapsed from the start of the specific super frame, it is not necessary to take synchronization for all transmission links into consideration.

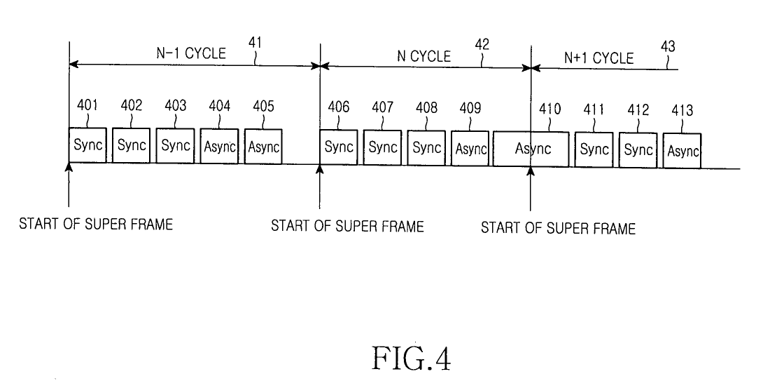

FIG. 4 shows a first scheme for processing Async frames to achieve a strict periodical synchronization for the start of super frames in the residential Ethernet system according to the present invention. In particular, FIG. 4 shows a hold scheme for processing the Async frames in order to achieve a strict periodical synchronization for the start of super frames in the residential Ethernet system according to the present invention.

Referring to FIG. 4, Sync frames 401, 402, 403, 406, 407, 408, 411 and 412 and Async frames 404, 405, 409, 410 and 413 are transmitted during cycles 41, 42 and 43.

As shown in FIG. 4, synchronization for the start of the super frame in the N cycle 42 is precisely obtained. This can be obtained by controlling the transmission of the Async frames in the N-1 cycle 41. The transmission control procedure for the Async frame is as follows:

In the case of the N-1 cycle 41, an empty transmission field still remains after the Async frame 405 has been transmitted, but the size of this empty transmission field is smaller than the size of the Async frame 409, which is the first Async frame in the N cycle 42. In this case, the Async frame 409 is controlled such that the Async frame 409 is transmitted during the next N cycle 42, thereby achieving the strict synchronization for the start of the super frames with a predetermined interval.

According to the above hold scheme, the size of the Async frame to be transmitted is compared with the size of the empty transmission field. If the size of the Async frame to be transmitted is larger than the size of the empty transmission field, transmission may be performed while maintaining the empty transmission field as it is. In addition, the Async frame is transmitted in the next cycle.

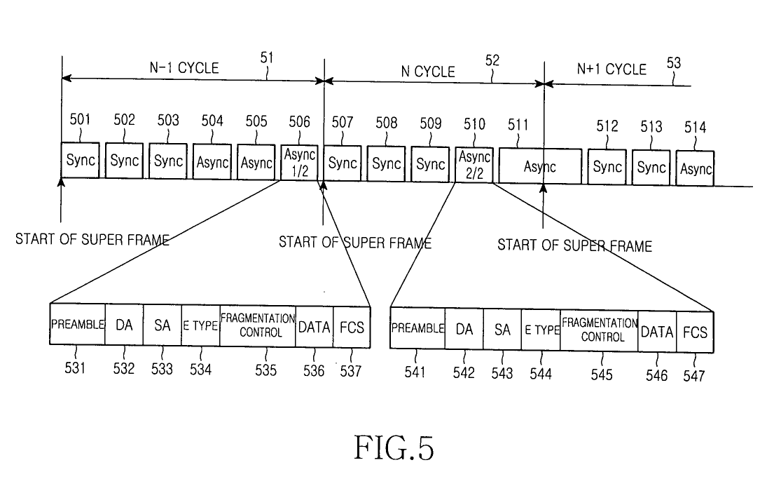

FIG. 5 is a view illustrating a second scheme for processing Async frames to achieve strict periodical synchronization for the start of super frames in the residential Ethernet system according to the present invention.

FIG. 5 shows a fragmentation scheme for processing the Async frames in order to achieve a strict periodical synchronization for the start of super frames in the residential Ethernet system according to the present invention.

Referring to FIG. 5, Sync frames 501, 502, 503, 507, 508, 509, 512 and 513 and Async frames 504, 505, 506, 510, 511 and 514 are transmitted during cycles 51, 52 and 53.

As shown in FIG. 5, synchronization for the start of the super frame in the N cycle 52 is precisely obtained. This can be obtained by controlling the transmission of the Async frames in the N-1 cycle 51. The transmission control procedure for the Async frame is as follows:

In the case of the N-1 cycle 51, an empty transmission field still remains after the Async frame 505 has been transmitted, but the size of this empty transmission field is smaller than the size of the Async frames 506 and 510 to be currently transmitted. In this case, the Async frame is fragmented such that fragmented frames are discretely transmitted, thereby achieving a strict synchronization for the start of the super frames.

In detail, when it is assumed that the size of a transmission field in the N-1 cycle 51, which is emptied for transmitting Async data, and the size of Async data to be transmitted are L1 and L2, respectively, if L1 is identical to or larger than L2, the Async data are input into the empty frame so as to be transmitted.

However, if L2 is larger than L1, the Async data having the size of L2 is fragmented into a 1/2 Async frame 506 having the size corresponding to the size L1 of the empty transmission field and a remaining Async frame having the size of “L2-L1”, so that the 1/2 Async frame 506 is transmitted through the N-1 cycle 51. At this time, the 1/2 Async frame 506 includes a preamble field 531, a DA field 532, an SA field 533, an E type field 534, a fragmentation control field 535, a data field 536 and an FCS field 537.

In addition, the remaining Async frame having the size of “L2-L1” is added to the 2/2 Async frame 510, which is the first Async frame in the N cycle 52, and is transmitted through the N cycle 52. At this time, the 2/2 Async frame 510 may not simply consist of the remaining fragmented Async frame having the size of “L2-L1”, but includes a preamble field 541, a DA field 542, an SA field 543, an E type field 544, a fragmentation control field 545, a data field 546 and an FCS field 547, which are similar to those of the 1/2 Async frame 506.

That is, each of fragmented Async frames 506 and 510 includes the preamble field 531 or 541, which consists of 8-bytes and indicates the start and end of the Async frame, the DA (destination address) field 531 or 542, which consists of 6-bytes and indicates the MAC (media access control) address of destination to which the Async frame must be transmitted, the SA (source address) field 533 or 543, which consists of 6-bytes and indicates the MAC (media access control) address of a station transmitting the Async frame, the E type (Ethernet type) field 534 or 544, which consists of 2-bytes and indicates the protocol type of the Async frame, the fragmentation control field 535 or 545, which consists of 2-bytes and indicates the fragmentation of the Async frame being transmitted, the data field 536 or 546 for receiving data to be transmitted, and the FCS (frame check sequence) field 537 or 547, which consists of 4-bytes and is located at an end portion of each frame so as to detect an error when information is discretely transmitted through frames during data communication.

The fragmentation control field 535 or 545 includes a 1-bit More flag for indicating the fragmentation of the frame being transmitted and a 15-bit sequence used for recombining the fragmented frames at a receiver side. That is, frames having the same sequence number are collected and recombined at the MAC address of the receiver side. In addition, the new E type 534 or 544 for a new frame fragmented from the Async frame is set to “0x8889” and the More flag of the frames except for a final fragmented frame is set to “1”. The More flag of the final fragmented frame is set to “0”. However, the above values are illustrative purpose only and are not intended to limit the scope of the present invention. The above values are changeable depending on the system.

In addition, when the frame is fragmented into the 1/2 Async frame 506 and the 2/2 Async frame 510, an Ethernet header and 2-byte fragmentation information attached to the 1/2 Async frame 506 are reused for the 2/2 Async frame 510.

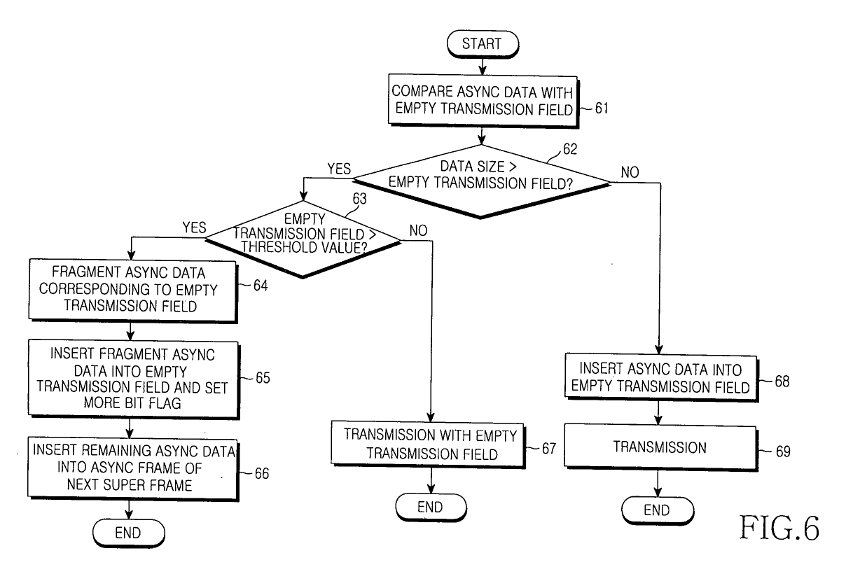

FIG. 6 is a flowchart illustrating a third scheme for processing Async frames to achieve a strict periodical synchronization for the start of super frames in the residential Ethernet system according to the present invention. In particular, FIG. 6 shows a hold-fragmentation scheme for processing the Async frames in order to achieve the strict periodical synchronization for the start of super frames in the residential Ethernet system according to the present invention.

The hold-fragmentation scheme adopts both the hold scheme and the fragmentation scheme and selectively uses the hold scheme or the fragmentation scheme based on a threshold value so as to strictly ensure the start of the super frame.

First, the size L2 of the Async frame to be transmitted is compared with the size L1 of an empty transmission field of the super frame (step 61).

If the size L2 of the Async frame to be transmitted is identical to or smaller than the size L1 of the empty transmission field of the super frame (step 62), transmission of the super frame is performed while inputting the Async data into the empty transmission field of the super frame (steps 68 and 69).

In contrast, when it is determined in step 61 that the size L2 of the Async frame is larger than the size L1 of the empty transmission field of the super frame, it is checked whether the size L1 of the empty transmission field of the super frame exceeds the predetermined threshold value (step 63).

The predetermined threshold value is established such that the frame fragmentation can be performed only when the empty transmission field has the size sufficient for the frame fragmentation. That is, if the size of the empty transmission field is insufficient for forming the header of the Async frame, the frame fragmentation is not necessary. In the embodiment, the predetermined threshold value is 48-bytes.

Such a threshold value of 48-bytes is established on account of 22-bytes of the header field of the Async frame including the preamble, DA, SA, and E type fields, 2-bytes of the fragmentation control field added for controlling fragmentation of the Async frame, and 24-bytes of the IFG field used for distinguishing between frames.

If it is determined in step 63 that the size L1 of the empty transmission field of the super frame exceeds the predetermined threshold value, the fragmentation scheme is employed.

The procedure of the fragmentation scheme is as follows:

First, Async data are fragmented corresponding to the size L1 of the empty transmission field of the super frame (step 64). Then, the fragmented Async data are input into the empty transmission field of the super frame and the More flag is established (step 65).

In addition, the remaining Async data having the size (L2-L1) is transmitted while being inserted into the first Async frame of the super frame located in the next transmission cycle.

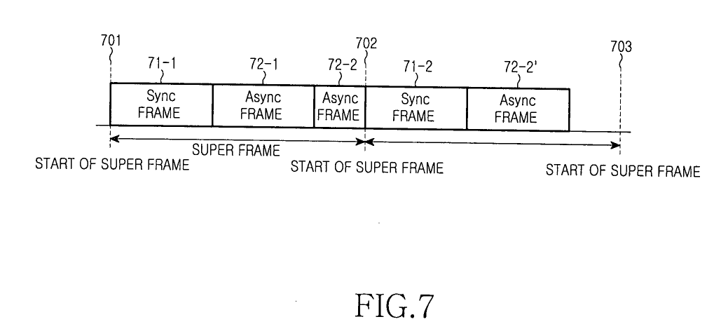

FIG. 7 is a view illustrating a fourth scheme for processing Async frames to strictly achieve a periodical synchronization for the start of super frames in the residential Ethernet system according to the present invention. In particular, FIG. 7 shows a RUNT scheme for processing the Async frames in order to achieve the strict periodical synchronization for the start of super frames in the residential Ethernet system according to the present invention.

According to the RUNT scheme, when the start 703 of the super frame must be strictly ensured without using a separate algorithm in the residential Ethernet system, transmission of an Async frame 72-2 being currently transmitted is stopped and a Sync frame 71-2 is transmitted at the start of the super frame.

At this time, it can be checked through the frame check sequence (FCS) that the super frame including the Async frame 72-2 is not completely transmitted, so the Async frame 72-2 is discarded.

Thus, an Async frame 72-2′ is newly transmitted in the next super frame.

As described above, the present invention can simplify the structure of the residential Ethernet system while efficiently utilizing the bandwidth for the Async frame.

Accordingly, since the structure of the residential Ethernet system can be simplified and the bandwidth for the Async frame can be efficiently used in the residential Ethernet system, the present invention can enhance competitiveness of the residential Ethernet system.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of performing a periodical synchronization at a predetermined transmission link for ensuring a start of a super frame in a residential Ethernet system, the method comprising the steps of-.
i) ensuring a start of a first predetermined super frame at the predetermined transmission link;
ii) transmitting Sync frames and Async frames through a predetermined number (N-1) of super frames, in which N is a total number of the super frames; and
iii) controlling an Async frame to be transmitted at an end point of the N-1) super frames in such a manner that a start of a next super frame (N^{th} super frame) is strictly ensured, thereby maintaining a synchronization for the start of the super frame.

2. The method as claimed in claim 1, wherein, in step iii), if an empty transmission field in an (N-1)^{st} super frame has a size smaller than a size of the Async frame to be transmitted, the Async frame is held and transmission is performed while maintaining the empty transmission field of the (N-1)^{st} super frame as it is.

3. The method as claimed in claim 2, wherein the Async frame being held is transmitted at an Async frame area of the N^{th} super frame.

4. The method as claimed in claim 1, wherein, in step iii), if an empty transmission field in an (N-1)^{st} super frame has a size smaller than a size of the Async frame to be transmitted, the Async frame is fragmented into a first fragmented Async frame having a size corresponding to the size of the empty transmission field and a second fragmented Async frame in such a manner that the first fragmented Async frame is transmitted while being input into the empty transmission field and the second fragmented Async frame is transmitted at an Async frame area of the N^{th} super frame.

5. The method as claimed in claim 4, wherein the fragmented Async frame includes a preamble field for indicating the start and end of the Async frame, a DA (destination address) field for indicating a MAC (media access control) address of destination to which the Async frame is transmitted, an SA (source address) field for indicating an MAC address of a station transmitting the Async frame, an E type (Ethernet type) field for indicating a protocol type of the Async frame, a fragmentation control field for indicating fragmentation of the Async frame being transmitted, a data field for receiving data to be transmitted through the Async frame, and an FCS (frame check sequence) field located at an end portion of each frame so as to detect an error when information is discretely transmitted through frames during data communication.

6. The method as claimed in claim 1, wherein, if an empty transmission field in an (N-1)^{th} super frame has a size smaller than a size of the Async frame to be transmitted, step iii) comprises the substeps of:
iv) comparing the size of the empty transmission field with a predetermined threshold value;
v) fragmenting the Async frame into a first fragmented Async frame having a size corresponding to the size of the empty transmission field and a second fragmented Async frame if the size of the empty transmission field is larger than the predetermined threshold value in such a manner that the first fragmented Async frame is transmitted while being input into the empty transmission field and the second fragmented Async frame is transmitted at an Async frame area of the N^{th} super frame; and
vi) holding the Async frame and performing transmission while maintaining the empty transmission field as it is, if the size of the empty transmission field is smaller than the predetermined threshold value.

7. The method as claimed in claim 4, wherein the Async frame fragmented in step v) includes a preamble field for indicating the start and end of the Async frame, a DA (destination address) field for indicating a MAC (media access control) address of destination to which the Async frame is transmitted, an SA (source address) field for indicating an MAC address of a station transmitting the Async frame, an E type (Ethernet type) field for indicating a protocol type of the Async frame, a fragmentation control field for indicating fragmentation of the Async frame being transmitted, a data field for receiving data to be transmitted through the Async frame, and an FCS (frame check sequence) field located at an end portion of each frame so as to detect an error when information is discretely transmitted through frames during data communication.

8. The method as claimed in claim 1, wherein, in step iii), if a next super frame is started while a predefined Async frame is being transmitted through a predefined super frame, transmission of the Async frame is stopped and transmission of a Sync frame occurs at the start of the next super frame.

9. The method as claimed in claim 8, wherein, if the transmission of the Async frame is stopped, discarding the Async frame through performing a frame check sequence (FCS) and newly transmitting the stopped Async frame at an Async frame area of the next super frame.

10. A method of ensuring a start of a super frame in a residential Ethernet system, the method comprising the steps of:
i) selectively ensuring a start of a super frame at a predetermined transmission interval;
ii) transmitting Sync frames and Async frames via other super frames; and
iii) after the predetermined interval has elapsed from the start of the super frame, selectively ensuring a start of a next super frame.

11. The method as claimed in claim 10, further comprising the step of selectively controlling the Async frame to be transmitted at an end point of the other super frames in such a manner that a start of the next super frame is strictly ensured.

12. The method as claimed in claim 10, wherein, if an empty transmission field in the next super frame has a size smaller than a size of the Async frame to be transmitted, the Async frame is held and transmission is performed while maintaining the empty transmission field of the next super frame as it is.

13. The method as claimed in claim 12, wherein the Async frame being held is transmitted at an Async frame area of the next super frame.

14. The method as claimed in claim 11, wherein, if an empty transmission field in the mext super frame has a size smaller than a size of the Async frame to be transmitted, the Async frame is fragmented into a first fragmented Async frame having a size corresponding to the size of the empty transmission field and a second fragmented Async frame in such a manner that the first fragmented Async frame is transmitted while being input into the empty transmission field and the second fragmented Async frame is transmitted at an Async frame area of the next super frame.

15. The method as claimed in claim 14, wherein the fragmented Async frame includes a preamble field for indicating the start and end of the Async frame, a DA (destination address) field for indicating a MAC (media access control) address of destination to which the Async frame is transmitted, an SA (source address) field for indicating an MAC address of a station transmitting the Async frame, an E type (Ethernet type) field for indicating a protocol type of the Async frame, a fragmentation control field for indicating fragmentation of the Async frame being transmitted, a data field for receiving data to be transmitted through the Async frame, and an FCS (frame check sequence) field located at an end portion of each frame so as to detect an error when information is discretely transmitted through frames during data communication.

16. The method as claimed in claim 11, wherein, if an empty transmission field in the next super frame has a size smaller than a size of the Async frame to be transmitted,
comparing the size of the empty transmission field with a predetermined threshold value;
fragmenting the Async frame into a first fragmented Async frame having a size corresponding to the size of the empty transmission field and a second fragmented Async frame if the size of the empty transmission field is larger than the predetermined threshold value in such a manner that the first fragmented Async frame is transmitted while being input into the empty transmission field and the second fragmented Async frame is transmitted at an Async frame area of the Nth super frame; and
holding the Async frame and performing transmission while maintaining the empty transmission field as it is, if the size of the empty transmission field is smaller than the predetermined threshold value.

17. The method as claimed in claim 14, wherein the Async frame fragmented includes a preamble field for indicating the start and end of the Async frame, a DA (destination address) field for indicating a MAC (media access control) address of destination to which the Async frame is transmitted, an SA (source address) field for indicating an MAC address of a station transmitting the Async frame, an E type (Ethernet type) field for indicating a protocol type of the Async frame, a fragmentation control field for indicating fragmentation of the Async frame being transmitted, a data field for receiving data to be transmitted through the Async frame, and an FCS (frame check sequence) field located at an end portion of each frame so as to detect an error when information is discretely transmitted through frames during data communication.

18. The method as claimed in claim 1, wherein, if the next super frame is started while a predefined Async frame is being transmitted through a predefined super frame, transmission of the Async frame is stopped and transmission of a Sync frame occurs at the start of the next super frame.

19. The method as claimed in claim 18, wherein, if the transmission of the Async frame is stopped, discarding the Async frame through performing a frame check sequence (FCS) and newly transmitting the stopped Async frame at an Async frame area of the next super frame.
